(19) United States
(12) Patent Application Publication
(10) Pub. No.: US 2003/0154160 A1
(43) Pub. Date: Aug. 14, 2003

(54) System and method for controlling electronic exchange of access to a leisure asset

(76) Inventor: Erick Arndt, Manchester, NH (US)

Correspondence Address: BOURQUE & ASSOCIATES, P.A., 835 HANOVER STREET, SUITE 303, MANCHESTER, NH, 03104, US

(21) Appl. No.: 10/367,149

(22) Filed: Feb. 14, 2003

Related U.S. Application Data
(60) Provisional application No. 60/356,797, filed on Feb. 14, 2002.

(51) Int. Cl. G06F 17/60

(52) U.S. Cl. 705/37; 705/36; 705/35

(57) ABSTRACT

A system and method for the exchange of an asset, preferably a leisure asset is disclosed. The system allows a user and/or an artificial intelligence module to search an asset database containing information about a number of assets other users have listed for an acceptable asset to exchange. Once a potential exchange asset is identified, the user makes an offer. If the offer is accepted, a validity checker validates the parties' rights ownership, exchange and use rights. Because the validation of ownership and use rights occur only after an exchange offer has been accepted, and is performed as of the time of utilization (and not simply the time the information is entered into the database), the quality of the information contained in the proposed exchange is greatly enhanced and the likelihood of fraud is greatly reduced. At any time until the completion of a proposed exchange, the users may amend or remove the asset from the asset database.

### CROSS-REFERENCE TO RELATED APPLICATIONS

This application claims the benefit of U.S. Provisional Application No. 60/356,797, filed Feb. 14, 2002 and fully incorporated herein by reference.

### TECHNICAL FIELD

The present invention relates to the exchange of assets and rights to use assets and more particularly, relates to validation and exchange of assets to prevent fraud.

### BACKGROUND INFORMATION

Timesharing or vacation ownership began in Europe in the middle of the 1960's. Ski resorts in the French Alps were the first to experiment with the idea. Later, in the 1970's the ideas and procedures became well known. It is now estimated that over 7 million timeshares have been sold since 1980 and currently there are approximately 6,000 vacation ownership resorts in over 80 countries.

The idea of exchanging a vacation ownership week for another vacation week in a different resort began in 1974 when Resort Condominiums International (RCI) was formed by Christel and John DeHaan. Other companies such as Interval International (II) subsequently joined the timeshare industry and in 2002, both companies performed over 3 million exchanges using a restricted, cumbersome, slow, and expensive process for the timeshare owner.

In recent times, websites on the Internet have been developed which act as a classified section or bulletin board for people to post their name and phone number to be contacted by interested parties. This leads to the development of programs having a database in which user's may enter information related to their timeshare such as the location, week, description, etc. When a user enters the information, the user is required to certify ownership of the timeshare before the timeshare is posted for others to view. Once the timeshare has been certified and posted on the database, the timeshare is “debited” against the user's account such that the timeshare is no longer available to the owner to use, even if no exchange of timeshare during the desired period of time or in the desired geographic location is located. Timeshare exchange programs such as RCI and II utilize this methodology.

The known methods of exchanging timeshares suffer from several known problems. The first problem is that the timeshare information is “certified” only prior to posting on the database. Timeshares often require a maintenance fee that must be paid periodically. If the “owner” does not pay the maintenance fee, the “owner” loses their privileges to use that property. As such, the “owner” can no longer exchange that timeshare. Such prior art systems also suffer from the fact that they operate as a pure “debit” and “credit” system, placing a “value” on each timeshare that is deposited as well as withdrawn. An individual deposits an asset and gets a credit (based on the value of asset); withdraws an asset and gets a debit. Such a system is not a true exchange or barter system which encourages and fosters exchange of rights to an asset.

Another problem with the known systems is that once an “owner” enters the timeshare into the database, the “owner” loses their rights to remove that timeshare from the database and to exercise their rights to the timeshare. As a result, if the “owner” is unable to enter into a desired exchange of the timeshare before the expiration of their rights, the “owner” is left with nothing. Consequently, the “owner” of a timeshare is placed in an inferior bargaining position relative to others since the timeshare “owner” must exchange their timeshare rights or lose them entirely. Because of this known weakness, the timeshare “owner” may be forced to exchange their timeshare for an inferior or less desirable timeshare.

Yet another problem with the known systems is that they do not provide for counter offers. As such, the bidder and seller are left with no options but to restart the exchange process which is cumbersome.

Accordingly, what is needed is a system that includes artificial intelligence that drives trade possibilities based on search criteria and user behavior, what asset a user makes offers on, what assets have been searched on, and other ways that show interest. Such a system also validates the asset information (including, for example, ownership of the asset) contemporaneously with the proposed asset exchange. The system should also allow the owner to withdraw their asset from the database at any time prior to the consummation of an asset exchange and should preferably have provisions for counter offers. Also it should allow users the freedom to propose and negotiate any trade with another user and not be limited by unknown or known rules defined by a third party. The system should not limit trades from one party to another, but engage as many parties as are needed in order to successfully propose and then complete a trade.

### SUMMARY

The present invention features a system and method of exchanging an asset. The method and system include generating a database containing asset information. Next, a user searches the database for an acceptable exchange asset using a search criteria and generates a list of acceptable assets. Acceptable assets may be of the same type as being placed into the database by the user or a different type of asset, as might be allowed. For example, a land based timeshare might be exchanged for a boat timeshare, or a motor home timeshare, etc. The search may be a one-to-one type exchange or a multiple-party type exchange. In the preferred embodiment, the method and system include an artificial intelligence program to match possible multiple-party exchanges.

Once an acceptable asset is identified, an offer is generated to at least a second party. The offer may include a like-kind exchange or an unlike-kind exchange. Contemporaneous with the offer, the system and method include validating the asset information using a validation program. The validation program authenticates the ownership and rights of the parties with respect to the assets with a third or outside party. After the assets have been validated, the parties may accept or reject the proposed exchange, or may propose a counter offer. Next, the asset information is updated in the asset database.

### BRIEF DESCRIPTION OF THE DRAWINGS

These and other features and advantages of the present invention will be better understood by reading the following detailed description, taken together with the drawings wherein:

FIG. 1 is a functional block diagram of the system according to the present invention;

FIG. 2 is flow diagram of the method according to the present invention;

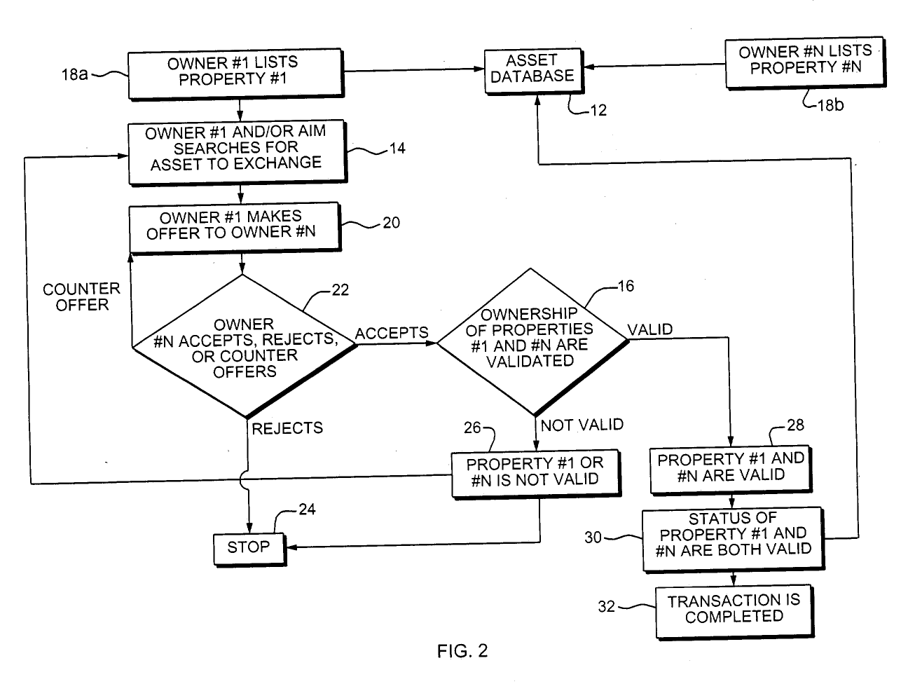

FIG. 3 is flow diagram of one embodiment of the method according to the present invention implementing one-to-one exchange; and

FIG. 4 is flow diagram of another embodiment of the method according to the present invention implementing a multiple party exchange.

### DETAILED DESCRIPTION OF THE PREFERRED EMBODIMENTS

For clarity of disclosure, and not by way of limitation, the preferred embodiment of this invention is described in detail with respect to the exchange of leisure assets (for example timeshares, “points” at a resort, air fare, car rentals, services, sporting tickets, etc.). However, this invention is not so limited, and from the following detailed description it will be apparent to one of ordinary skill in the art that this invention is applicable to exchanges of tangible or intangible commodities of any sort. In addition, all references to an exchange of assets means both an exchange of the right to use the asset for a preset period of time as well as a permanent transfer or exchange of the asset.

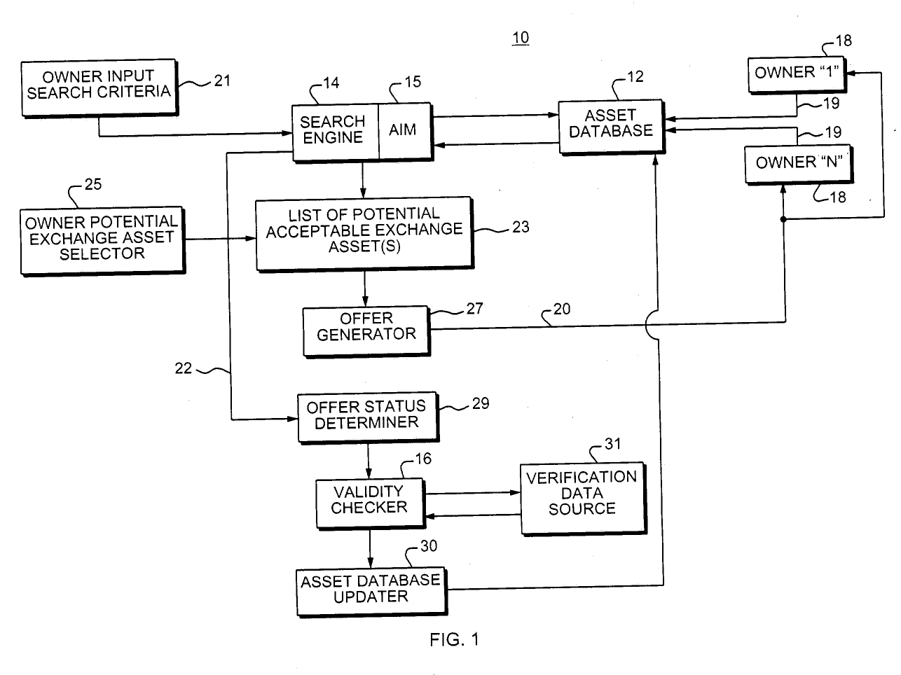

A system and method 10, FIG. 1, of exchanging an asset includes an asset database 12, a search engine 14, and a validation program 16. A plurality of users or asset owners 18 remotely establish a connection, preferably a secure digital communication connection, to an asset database 12. The users 18 then enter asset information 19 regarding the asset they desire to exchange into the database 12. The asset information 19 preferably includes information such as the user's name, address, contact information, the asset type (e.g., timeshare, air fare, event tickets, points, etc.), the location of the asset (e.g., resort name, geographic location, etc.), time of the asset (e.g., second week in July, New Years, etc.), and any other relevant features or information about the asset (e.g., near the beach, close to golf course, wood stove, number of bedrooms, bathrooms, amenities, etc.).

The users 18 also enter search criteria information 21 into the database 12 regarding one or more assets that they are interested in exchanging for, such as a timeshare in a specific resort in Florida for the second week in February. The asset database 12 preferably also includes asset ratings, general resort information, travel planners/organizers, and other traveling information. It is important to note that the user 18 may update, alter, or remove entirely the information contained in the asset database 12 at any time up until the asset has been successfully exchanged with another party.

A search engine 14 allows the users 18 to search the asset database 12 using the user's input search criteria 21 to find possible assets to exchange. In the preferred embodiment, the user 18 enters search criteria 21 into the search engine 14. The search criteria 21 includes information about the asset that the user 18 is interested in such as the asset type, location, time, etc.

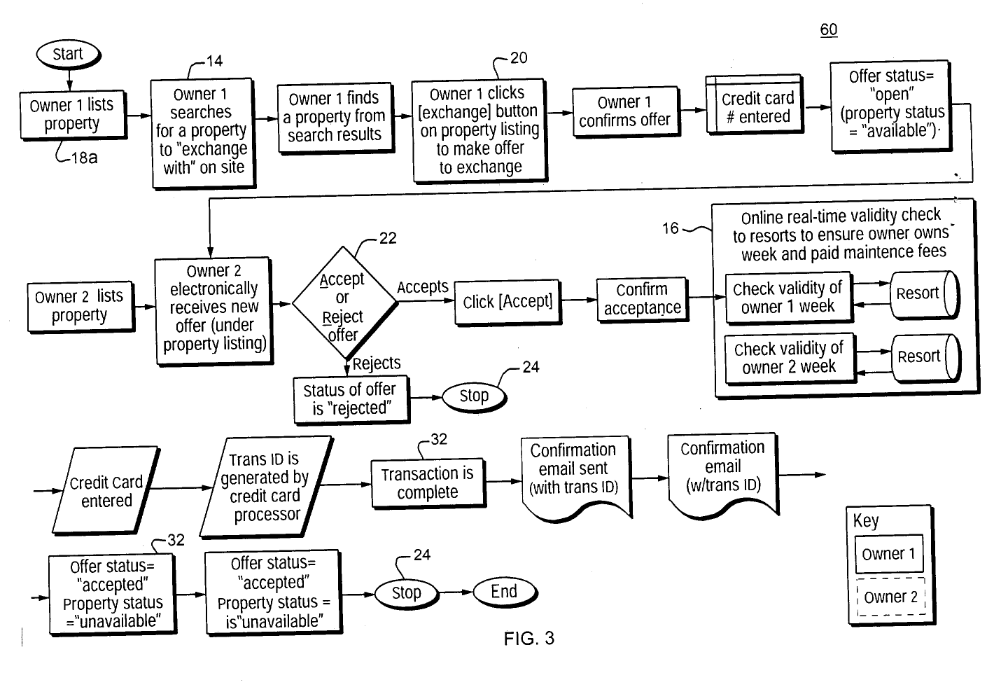

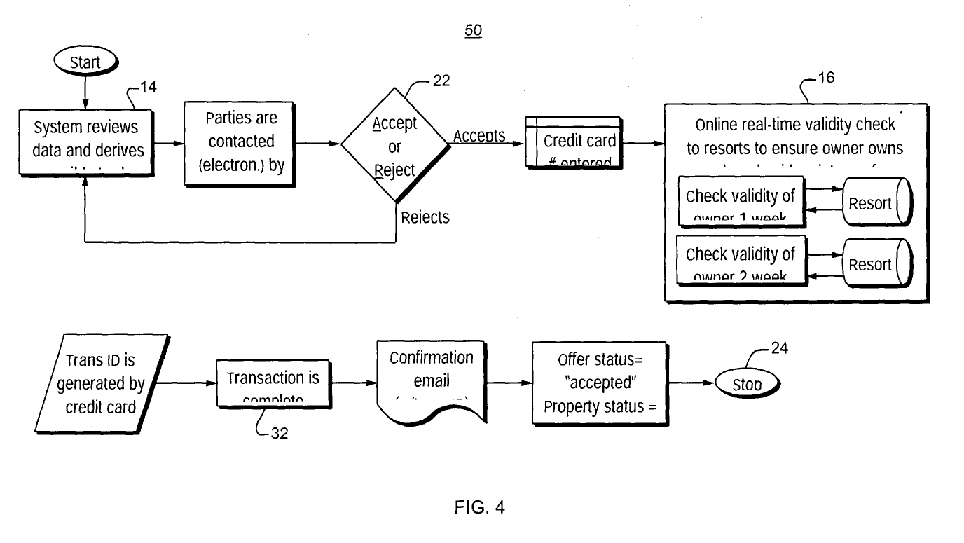

The search engine 14 then uses the search criteria to determine possible asset exchanges. The search engine 14 may include any type of search engine 14 known to those skilled in the art including, but not limited to, a simple key word search or a natural language search. In the preferred embodiment, the search engine 14 includes an artificial intelligence program or module. The artificial intelligence module attempts to determine as many matches as possible, and includes the ability to determine multiple-node or multiple-party type exchanges 50, FIG. 4, in addition to one-to-one type exchanges 60, FIG. 3.

The Artificial Intelligence Module (AIM) derives possible asset exchanges based on the owned and listed asset(s) of each member and the “behavior data” of the user using the system. Behavior data includes, but is not limited to, database search activity (e.g., searches by location, unit amenities, asset categories, asset types, asset ratings etc.), offers and other communication between parties (i.e. email, electronic Instant Messaging), research within the system, the saving and storing of certain asset files and information to personalized lists for later review and processing (e.g., known commonly as “Watchlists”), as well as “User Preference Lists” created by a user to identify what assets they are interested in finding and trading for in the system. The Artificial Intelligence Module analyzes the said data to derive permutations of various trade possibilities by including as many parties as is needed to complete a single trade. For example, the AIM may suggest an exchange involving two, three or more parties based on each parties “behavior data”.

The AIM then passes the information on to the Offering Module to create and send offers directly to the parties. A multiple-node or multiple-person exchange 50 involves three or more assets where a first party has an asset which a second party wants, the second party has an asset that a third party wants, and the third party has an asset that the first party wants. The ability to perform multiple-party exchanges 50 greatly enhances the chances of a successful exchange being made since it increases the users 18 ability to find other potential users 18.

In either embodiment, once the search has been completed the results are preferably displayed in a “hit list” 23. The user 18 then searches through the “hit list” 23 and evaluates the potential exchanges. If no potential exchanges are found, or the user 18 is not satisfied with any of the potential exchanges, the user 18 may either redefine their search criteria or exit the system 10. If the user decides to exit the system 10, the user 18 may store the search criteria to be run periodically and have the system 10 automatically notify the user 18 of a possible exchange in the future. Alternatively, the user 18 may opt to simply stop searching or remove the asset 19 from the asset database 12 altogether.

In the event that a user 18 identifies a satisfactory potential exchange, 25, the user 18a then makes an offer 20 to a second user 18b (or multiple users 18 in a multiple-party exchange) using an offer generator 27. The system 10 also includes the ability to send multiple offers 20 for a single asset to multiple users 18. According to this embodiment, the system 10 creates an auction whereby the multiple users 18 may bid against each other for the asset. The auction may be either open (wherein any users 18 of the system may bid) or may be private (wherein only the users 18 who received offers may bid). The offer 20 may include a like-kind exchange or an unlike-kind exchange.

A like-kind exchange is an exchange where both assets are of a similar type, nature, or quality. For example, a first user 18a may own a timeshare in Florida and propose an exchange to a second user 18b who has a timeshare in New Hampshire. An unlike-kind exchange is any exchange where the assets being exchanged are of dissimilar type or quality. This may include, for example, the exchange of money for a timeshare or airline points or miles for a car rental.

Upon making the offer 20, the second user 18b may accept, reject, or counter offer 22, as monitored by the offer status determinator 29. If the offer is rejected, the users may make a counter offer, may resume searching, may make another offer to another party 18, or stop 24 the system 10.

After the offer has been accepted, the system 10 includes a validity checker 16. The validity checker 16 reduces the likelihood of fraudulent exchanges by authenticating at least a portion of the information contained in the asset database 12. The validity checker 16 preferably authenticates the ownership and right of the users 18 to the assets with an outside or third party source 31. In the preferred embodiment, the validity checker 16 contacts the asset controller (for example the resort, credit card company, air line company, etc.) to verify that the user 18 owns the asset, has the right to use and transfer the use of the asset, has paid all necessary fees and taxes, and verifies the quality of the information entered into the database such as the location, amenities, etc. The specific information that is validated will, of course, depend upon the exact type of asset in question, and is within the knowledge of one of ordinary skill in the art.

It is common for users 18 to trade assets in which at least one of the assets will not be utilized until after the other asset has been utilized. In the event that at least one of the assets to be exchanged will be utilized in the future, the validity checker 16 preferably verifies that all rights to that asset are secured as of the date of use of that asset, and not merely the proposed exchange date. This prevents the situation where a first user's 18a rights to the asset involved in the exchange are valid as of the time of the proposed exchange, but then the user 18a later fails to make the required payments after the proposed exchange date and thereby loses the rights to that asset as well as the ability to transfer those rights. By validating the user's 18 rights to the assets as of their use date, the likelihood of fraud is greatly reduced.

In the exemplary embodiment, the system 10 initially validates the asset information 19 upon entering the asset information into the database 12, and may optionally validate the information 19 randomly thereafter. By validating the asset after a potential exchange has been identified but before the exchange is consummated, the possibility of fraud is greatly reduced and the user's asset is not tied up until an exchange transaction is ultimately consummated.

If one or more of the assets is determined to be invalid 26, the users 18 may, at the election of the non-invalid user 18, opt to terminate or stop the proposed exchange or may continue with the exchange. If the user 18 stops the proposed exchange, the user 18 may resume searching 14.

If all of the assets are determined to be valid 28 (or the non-invalid user 18 opts to continue), the status of the assets are updated 30 within the asset database 12 to indicate that they are no longer available for exchange and the exchange is completed 32. According to the preferred embodiment, notifications are sent to each of the users 18 as well as the asset holder (e.g. the resort) to verify the exchange.

Accordingly, the system 10 allows a user 18 to search 14 the asset database 12 for an acceptable asset to exchange. Once the asset is identified, the user 18 makes an offer 20. Only once an offer to exchange is accepted will the validation program 16 validate the asset information. Because the validation program 16 validates the ownership at the time of utilization (and not simply the time the information is entered into the database), the quality of the information contained in the proposed exchange is greatly enhanced and the likelihood of fraud is greatly reduced. At any time until the completion of a proposed exchange, the users 18 may amend or remove the asset from the asset database 12, thus ensuring that all the user's 18 are on an equal bargaining position.

Modifications and substitutions by one of ordinary skill in the art are considered to be within the scope of the present invention, which is not to be limited except by the following claims.

The invention claimed is:

1. A method of exchanging an asset comprising the acts of:
providing a database containing asset information;
searching said database for a potential exchange asset using at least one search criteria provided by a first party;
generating, responsive to said searching, a list of potential exchange assets, said list of potential exchange assets including at least one potential acceptable exchange asset using said first party at least one search criteria, said at least one potential acceptable exchange asset belonging to at least one second party;
generating an offer to said at least one second party to exchange an asset of said first party with said at least one potential acceptable exchange asset selected from said list;
receiving an indication from said second party accepting or rejecting said offer;
responsive to an indication from said second party accepting said offer, validating said asset information of said first and second parties; and
updating said asset information in said database reflecting said exchange of assets between said first and second parties.

2. The method as claimed in claim 1 wherein said act of searching includes a one-to-one exchange wherein said first party's criteria are matched to search criteria input by said second party.

3. The method as claimed in claim 1 wherein said act of searching includes a multiple-party exchange wherein said first, said second, and at least a third party's search criteria are matched contemporaneously.

4. The method as claimed in claim 3 wherein said multiple-party exchange includes an artificial intelligence program which matches said first, said second, and at least said third party's search criteria to propose possible exchanges.

5. The method as claimed in claim 1 wherein said act of accepting or rejecting said offer further includes proposing a counter offer.

6. The method as claimed in claim 1 wherein said act of generating said offer further includes a like-kind exchange.

7. The method as claimed in claim 1 wherein said act of generating said offer further includes an unlike-kind exchange.

8. The method as claimed in claim 1 wherein said act of validating said asset includes authenticating said asset information is as of a time wherein said assets are to be utilized.

9. The method as claimed in claim 1 wherein said act of validating said asset includes authenticating the ownership and rights of said parties to said assets with an outside party.

10. The method as claimed in claim 9 wherein said act of authenticating the rights of said parties to said assets further includes authenticating privileges to said asset and the payment of required fees and taxes with said outside party.

11. The method as claimed in claim 10 wherein said fees include the payment of maintenance fees and said privileges includes the right to transfer use of said asset.

12. The method as claimed in claim 1 further including the act of generating and sending reservations to said parties and said outside party upon completion of said transaction.

13. The method as claimed in claim 1 wherein the act of searching said database for a potential exchange asset includes utilizing an artificial intelligence module, receiving as input behavior data, to search for potential exchange assets between two or more users.

14. A system for the exchange of assets including:
a database comprising a plurality of user asset accounts, each of said user asset accounts including a description of said asset;
a search engine, responsive to potential exchange asset search criteria input from at least a first party, for searching said database using said potential exchange asset search criteria and generating a list of potential acceptable assets for exchange using said criteria, wherein a first user may evaluate said list of acceptable assets for exchange and generate an offer to at least a second user;
an offer generator, responsive to said first party selecting at least one potential acceptable asset from said list of potential acceptable assets, for transmitting an exchange offer to a second party listing said selected potential acceptable asset;
an offer status monitor, for receiving an indication from said second party as to whether said second party has accepted or rejected said exchange offer from said first party;
an asset validity checker, responsive to an indication from said offer status monitor that said second party has accepted said exchange offer from said first party, for validating said description of said asset input by said first and second parties, and for validating the ownership and use rights of said assets listed by said first and second parties.

15. The system as claimed in claim 14 wherein said description of said asset includes the asset type, location, price, and time availability of said asset.

16. The system as claimed in claim 14 wherein said search engine includes a one-to-one exchange wherein said first party's criteria are matched to said second party's criteria.

17. The system as claimed in claim 14 wherein said search engine includes a multiple-party exchange wherein said first, said second, and at least a third party's search criteria are matched contemporaneously.

18. The system as claimed in claim 17 wherein said multiple-party exchange includes an artificial intelligence program which matches said first, said second, and at least said third party's search criteria to propose possible exchanges.

19. The system as claimed in claim 14 wherein said proposed exchange includes a like-kind exchange.

20. The system as claimed in claim 14 wherein said proposed exchange includes an unlike-kind exchange.

21. The system as claimed in claim 14 wherein said asset validity checker authenticates the ownership and rights of said parties to said assets with an outside party.

22. The system as claimed in claim 21 wherein said asset validity checker authenticates the right to transfer said asset and the payment of all required fees and taxes related to said asset with an outside party.

23. The system as claimed in claim 21 wherein said asset validity checker authenticates said description of said assets as of a time wherein said assets are to be utilized.

24. The system of claim 14 wherein said search engine includes an artificial intelligence module, receiving as input behavior data, for searching for potential exchange assets between two or more users.
